(19) United States
(12) Patent Application Publication
(10) Pub. No.: US 2017/0231246 A1
(43) Pub. Date: Aug. 17, 2017

(54) APPARATUS AND METHOD FOR INFUSING COFFEE BEANS WITH AN AROMATIC FLAVOR

(71) Applicant: William Andrew Thompson, Austin, TX (US)

(72) Inventor: William Andrew Thompson, Austin, TX (US)

(21) Appl. No.: 15/045,152

(22) Filed: Feb. 16, 2016

(51) Int. Cl. A23F 5/46; A23N 15/00

(52) U.S. Cl. CPC A23F 5/46; A23N 15/00

(57) ABSTRACT

A storage apparatus and method to infuse coffee beans with an aroma emanating from an aromatic substance is provided. The apparatus flavors the coffee beans with the aroma by storing the beans in proximity to the aromatic substance. The apparatus includes a container and a lid detachably coupled thereto to create an inner compartment to store the aromatic substance, a pedestal coupled to the bottom wall of the container, and an internal container disposed on the pedestal and having a plurality of openings, the internal container designed to store the coffee beans above the aromatic substance. The aroma emanating from the aromatic substance passes through the plurality of openings in the internal container and contacts the stored coffee beans, thereby infusing the coffee beans with the aroma.

### BACKGROUND

The embodiments herein relate generally to devices and methods for flavoring coffee beans.

Coffee beans are harvested, processed, flavored and/or roasted for human use. Generally, coffee beans are roasted and flavored through a series of steps prior to being shipped to the consumer. Current industry practices include flavoring the coffee beans during the roasting process with a variety of syrups or other aromatic substances. These syrups or other substances often contain one or more unnatural ingredients and/or preservatives that are undesirable for human consumption. Since the syrups, and/or other substances are dispensed directly onto the coffee beans, individuals consume these unnatural ingredients or preservatives when drinking coffee brewed from these beans.

Other procedures include disposing coffee beans in barrels previously used to store whiskey or other liquors. However, these methods also place the coffee beans in direct contact with the liquor, which may add undesirable ingredients to the beans. In addition, these techniques are not cost-effective or practical for many individuals due to the need to replace and/or maintain these barrels.

As such, there is a need in the industry for an apparatus and method for infusing coffee beans with an aromatic flavor that addresses the limitations of the prior art. Specifically, there is a need for an apparatus and method that infuses the coffee beans with a flavor without the coffee beans' absorption of any undesirable ingredients that may be present in the aromatic substance.

### SUMMARY

A storage apparatus configured to infuse coffee beans with an aroma emanating from an aromatic substance is provided. The apparatus is configured to flavor the coffee beans with the aroma by storing the beans in proximity to the aromatic substance. The apparatus comprises a container comprising a side wall, a bottom wall coupled to the side wall, and a lid detachably coupled thereto to create an inner compartment defined by space between the side wall, bottom wall and lid, the container configured to store the aromatic substance therein, a pedestal coupled to the bottom wall of the container, and an internal container disposed on the pedestal and comprising a plurality of openings configured to permit air to pass therethrough, the internal container configured to store the coffee beans and be positioned above the aromatic substance, wherein the aroma emanating from the aromatic substance passes through the plurality of openings in the internal container and contacts the stored coffee beans, thereby infusing the coffee beans with the aroma.

In certain embodiments, a method for infusing coffee beans with an aroma by placing an aromatic substance proximate the coffee beans in a storage apparatus is provided. The method comprises providing the storage apparatus, disposing the aromatic substance in the container such that the substance is below the internal container, disposing an amount of the coffee beans in the internal container, and securing the lid to the container to create a sealed and closed environment in the inner compartment for a period of time, thereby permitting the aroma emanating from the aromatic substance to pass through the plurality of openings in the internal container and contact the stored coffee beans.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a front perspective view of certain embodiments of the coffee bean storage apparatus;

FIG. 2 depicts a front perspective view of certain embodiments of the coffee bean storage apparatus illustrating a cut-away section;

FIG. 3 depicts an exploded view of certain embodiments of the coffee bean storage apparatus;

FIG. 4 depicts a section view of certain embodiments of the coffee bean storage apparatus taken along line 4-4 in FIGS. 1; and

FIG. 5 depicts a section view of certain embodiments of the coffee bean storage apparatus taken along line 5-5 in FIG. 4.

### DETAILED DESCRIPTION YE CERTAIN EMBODIMENTS

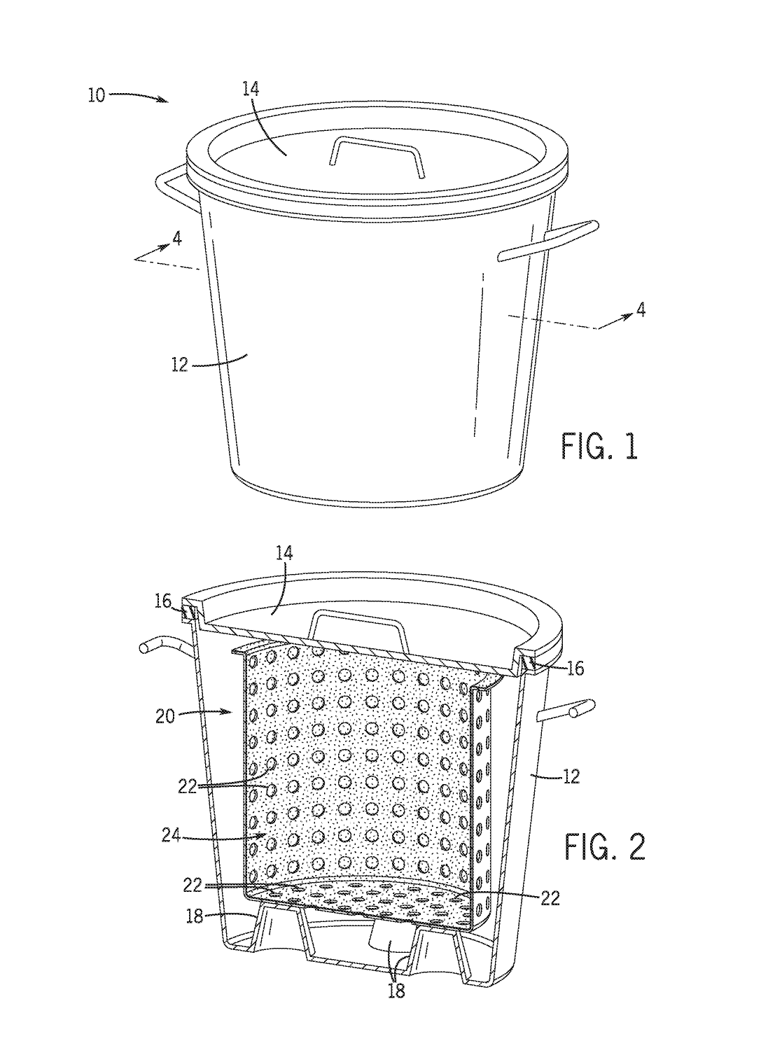

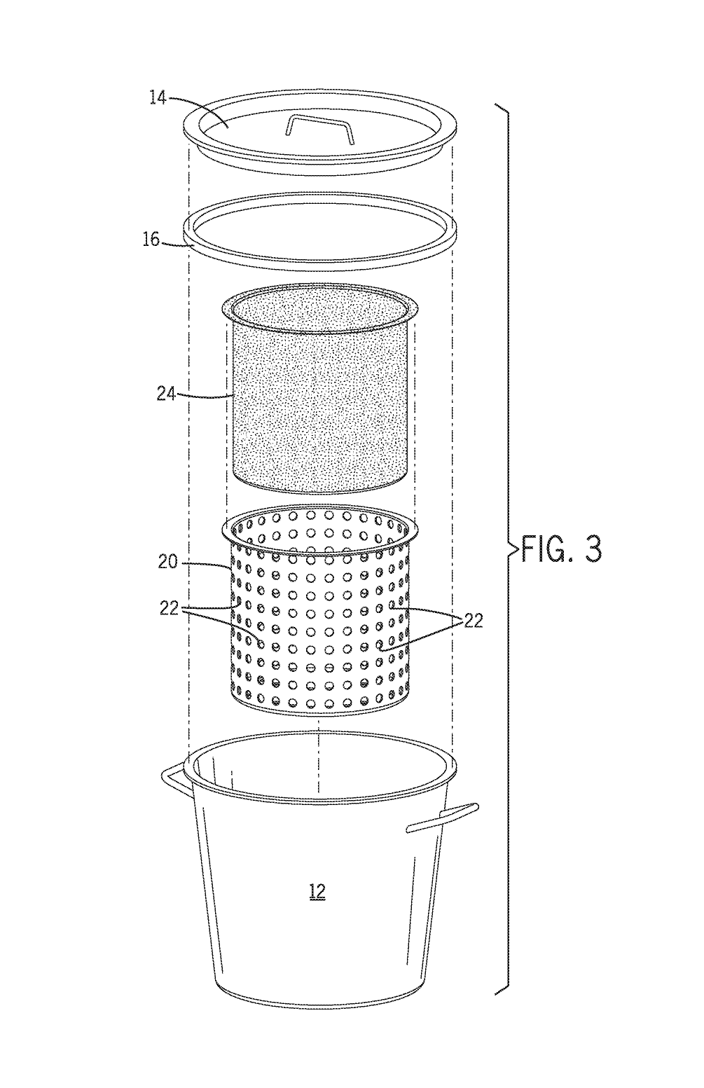

As depicted in FIGS. 1-4, coffee bean storage apparatus 10 is configured for use in infusing coffee beans 26 with an aroma emanating from aromatic substance 28. Coffee bean storage apparatus 10 generally comprises pot 12, lid 14, internal support container 20 and mesh container 24.

Pot 12 comprises a container such as a 60-Quart container made of a material such as aluminum, stainless steel, other metals or non-reactive materials. Pot 12 comprises an inner compartment that is sealed by lid 14. In one embodiment, gasket 16 is coupled to an upper portion of pot 12. Gasket 16 creates a seal between pot 12 and lid 14 when disposed thereto. Gasket 16 may be any type of material such as rubber, plastic, or other material known in the field. A plurality of pedestals 18 are coupled to the bottom wall of pot 12. In one embodiment three pedestals 18 are coupled to pot 12. However, any alternative number and orientation of pedestals 18 may be used, in one embodiment, pedestals 18 are fused into pot 12 as a single component. In an alternative embodiment, pedestals 18 and pot 12 may be separate components secured together.

Internal support container 20 comprises a basket with a plurality of openings 22 and is disposed on top of pedestals 18. In one embodiment, each opening 22 is generally circular and comprises an approximate diameter of ¼″. However, each opening 22 may have variable dimensions and shapes. Mesh container 24 comprises a screen member comprising a plurality of openings (not shown) to permit air to pass through. In a preferred embodiment, a first diameter of each opening 22 in internal support container 20 is greater than a second diameter of each opening in mesh container 24. It shall be appreciated that the openings in mesh container 24 should be sufficiently sized to prevent any stored coffee beans 26 therein from passing through. The use of internal support container 20 with mesh container 24 provides additional structural support to effectively store and retain coffee beans 26 therein.

In certain embodiments of the invention, an exemplary method for infusing coffee beans with an aroma emanating from aromatic substance 28 is provided. It shall be appreciated that modifications to the steps may be possible to achieve a desired level of flavor in the coffee beans.

In one embodiment of the invention, coffee bean storage apparatus 10 is provided. Lid 14 is removed from pot 12 to enable a user (not shown) to dispose aromatic substance 28 in the bottom of pot 12. Aromatic substance 28 is preferably a liquid such as sour mash whiskey. In one embodiment, approximately 1.75 liters of whiskey is used. However, the amount and type of aromatic substance 28 can vary. For example, alternative liquors, liquids or marinades may be used. In alternative embodiments, aromatic substance 28 may be a combination of herbs or spices such as cinnamon, peppers, or the like. The upper level of aromatic substance 28 should remain below the top surfaces of pedestals 18 to prevent contact between the whiskey and coffee beans 26.

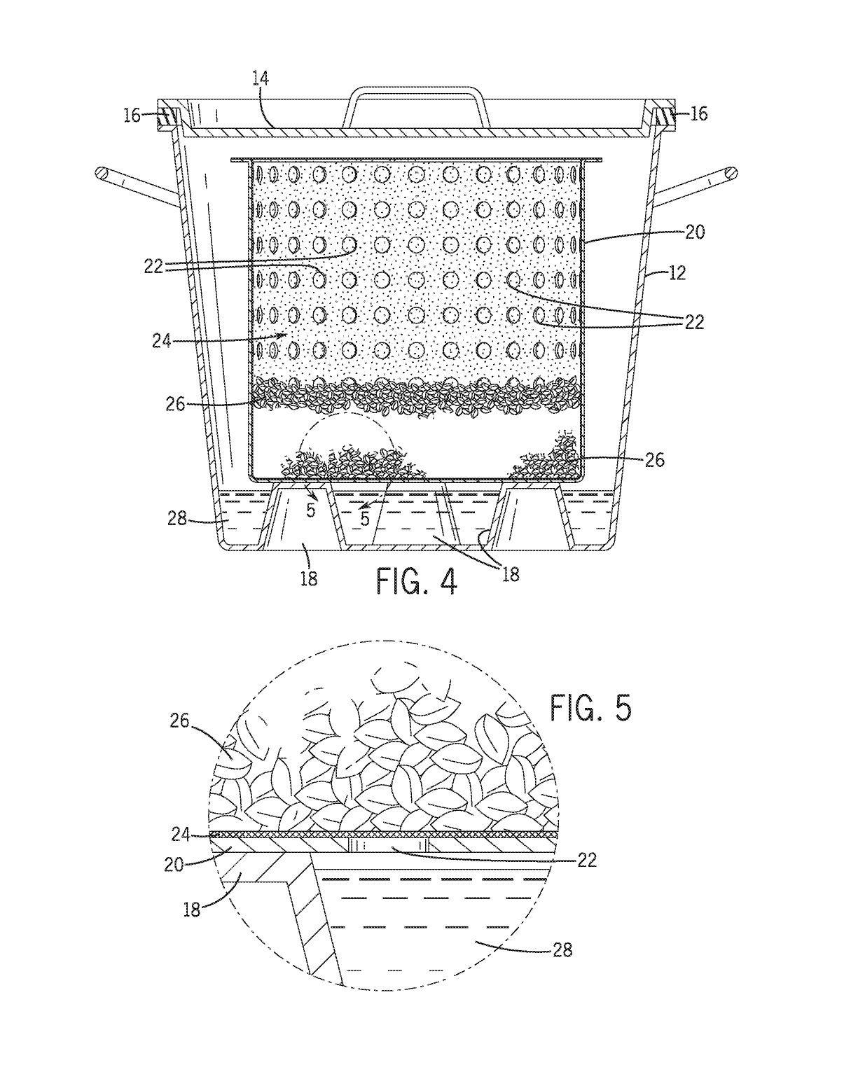

Approximately 20 lbs. of coffee beans 26 is disposed within mesh container 24. Coffee beans 26 may be any type of raw and unroasted beans known in the field. Mesh container 24 is inserted within internal support container 20, and the internal support container 20 and mesh container 24 combination is disposed on top of pedestals 18. As depicted in FIGS. 4-5, lid 14 is secured to pot 12 to create a closed environment to flavor coffee beans 26.

Coffee bean storage apparatus 10 remains in the closed environment for a time period of approximately 28 days. However, the time period may vary to alter the strength of flavor infused into coffee beans 26. In the closed environment, aroma emanating from aromatic substance 28 rises and passes through openings 22 in internal support container 20 and openings in mesh container 24 to contact coffee beans 26. Over time, this infuses coffee beans 26 with a desired flavor originating from the aroma. Gasket 16 maintains the seal between lid 14 and pot 12, and prevents the loss and/or evaporation of aromatic substance 28. After the completion of the desired time period, lid 14 is removed from pot 12. Coffee beans 26 are ready to be roasted and/or processed as desired by a consumer.

There are several benefits of using coffee bean storage apparatus 10. Since internal support container 20 and mesh container 24 are situated on pedestals 18 above aromatic substance 28, coffee beans 26 do not directly contact aromatic substance 28. This is advantageous because coffee beans 26 do not absorb any undesirable ingredients that may be present in aromatic substance 28. In addition, the use of coffee bean storage apparatus 10 is practical and low-cost because pot 12, lid 14, mesh container 24 and internal support container 20 can be reused. This contrasts existing coffee industry practices where expensive barrels may have to be disposed, replaced, maintained, and the like.

It shall be appreciated that the components of coffee bean storage apparatus 10 described in several embodiments herein may comprise any alternative known materials in the field and be of any color, size and/or dimensions. It shall be appreciated that the components of coffee bean storage apparatus 10 described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A storage apparatus configured to infuse coffee beans with an aroma emanating from an aromatic substance, the apparatus configured to flavor the coffee beans with the aroma by storing the beans in proximity to the aromatic substance, the apparatus comprising:
a container comprising a side wall, a bottom wall coupled to the side wall, and a lid de-tachably coupled thereto to create an inner compartment defined by space between the side wall, bottom wall and lid, the container configured to store the aromatic substance therein;
a pedestal coupled to the bottom wall of the container; and
an internal container disposed on the pedestal and comprising a plurality of openings configured to permit air to pass therethrough, the internal container configured to store the coffee beans and be positioned above the aromatic substance;
wherein the aroma emanating from the aromatic substance passes through the plurality of openings in the internal container and contacts the stored coffee beans, thereby infusing the coffee beans with the aroma.

2. The storage apparatus of claim 1, further comprising a mesh container disposed within the internal container and comprising a plurality of openings, the mesh container being positioned in between the internal container and the stored coffee beans, wherein the aroma emanating from the aromatic substance passes through the plurality of openings in both the internal container and mesh container, and contacts the stored coffee beans.

3. The storage apparatus of claim 2, wherein a first size of each opening in the internal container is greater than a second size of each opening in the mesh container.

4. The storage apparatus of claim 3, further comprising a gasket coupled to the container and configured to create a seal between the container and lid.

5. The storage apparatus of claim 4, wherein the aromatic substance is a liquor.

6. The storage apparatus of claim 5, wherein the pedestal comprises a plurality of pedestal members coupled to the bottom wall of the container, each pedestal member of the plurality of pedestal members configured to contact the internal container.

7. A method for infusing coffee beans with an aroma by placing an aromatic substance proximate the coffee beans in a storage apparatus, the method comprising:
providing the storage apparatus, the storage apparatus comprising:
a container comprising a side wall, a bottom wall coupled to the side wall, and a lid detachably coupled thereto to create an inner compartment defined by space between the side wall, bottom wall and lid;
a pedestal coupled to the bottom wall of the container; and
an internal container disposed on the pedestal and comprising a plurality of openings configured to permit air to pass therethrough;
disposing the aromatic substance in the container such that the substance is below the internal container;
disposing an amount of the coffee beans in the internal container; and
securing the lid to the container to create a sealed and closed environment in the inner compartment for a period of time, thereby permitting the aroma emanating from the aromatic substance to pass through the plurality of openings in the internal container and contact the stored coffee beans, thereby infusing the coffee beans with the aroma.

8. The method of claim 7, wherein the period of time is approximately 28 days,

9. The method of claim 8, wherein the storage apparatus further comprises a mesh container disposed within the internal container and comprising a plurality of openings, the mesh container being positioned in between the internal container and the stored coffee beans, wherein the aroma emanating from the aromatic substance passes through the plurality of openings in both the internal container and mesh container, and contacts the stored coffee beans.

10. The method of claim 9_{;} wherein the storage apparatus further comprises a gasket coupled to the container and configured to create a seal between the container and lid,
